(19) United States
(12) Patent Application Publication
(10) Pub. No.: US 2010/0005201 A1
(43) Pub. Date: Jan. 7, 2010

(54) MULTI-PROCESSOR SYSTEM AND FLUID EJECTING APPARATUS HAVING THE SAME

(75) Inventors: Shuji Otsuka, Shiojiri-shi (JP); Satoru Shibata, Shiojiri-shi (JP); Ryuichi Tsuji, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/497,412

(22) Filed: Jul. 2, 2009

(30) Foreign Application Priority Data
Jul. 2, 2008 (JP) 2008-173397

(51) Int. Cl. G06F 5/14

(52) U.S. Cl. 710/48

(57) ABSTRACT

A multi-processor system includes two or more processors, a message box in which messages are stored which have been sent from a transmitting processor to a receiving processor, which each correspond to one of the two or more processors, at an address in a matrix form which correspond to the transmitting processor and the receiving processor, and an interrupt signal output unit which outputs an interrupt signal to the receiving processor when a message is written in the message box.

### BACKGROUND

1. Technical Field

The present invention relates to a multi-processor system and a fluid ejecting apparatus having the same.

2. Related Art

Conventionally, as a multi-processor system, a technique is proposed which includes a first communication path which is formed by individually connecting a plurality of processors and a memory controller and a second communication path of a loop form which is formed by sequentially connecting a plurality of processors and a memory controller, and this configuration effectively achieves a connection between devices which configure a multi-processor (for example, JP-A-2007-122320).

In the multi-processor system disclosed in JP-A-2007-122320, in the case of communications between processors, a dedicated region for each processor is prepared in the main memory, and messages are read from the set dedicated region. However, there are problems with the multi-processor system in that a plurality of messages cannot be transmitted and that it is difficult to perceive which processor is the source.

### SUMMARY

An advantage of some aspects of the invention is that it provides a multi-processor system and a fluid ejecting apparatus having the multi-processor system in which messages can be more reliably exchanged between processors.

According to an aspect of the invention, there is provided a multi-processor system, including: two or more processors; a message box in which messages can be stored which have been sent from a transmitting processor to be destined for a receiving processor, which each correspond to one of the two or more processors mentioned above, at an address in a matrix form which correspond to the transmitting processor and the receiving processor; and an interrupt signal output unit which outputs an interrupt signal to the receiving processor when a message is written in the message box.

According to the multi-processor system, provided is a message box in which messages can be stored which have been sent from a transmitting processor to be destined for a receiving processor, which each correspond to one of the two or more processors mentioned above, at an address in a matrix form which correspond to the transmitting processor and the receiving processor. When a message is written in the message box, an interrupt signal is output to the receiving processor. Since a receiving side and a transmitting side correspond to an address in a matrix form, it is easy to perceive the relationship between the transmitter and the receiver. Further, when a message is written, this is informed to the receiving side, and thus it is easy for the receiving side to perceive whether or not a message is present. Therefore, a message can be reliably exchanged between processors.

According to the multi-processor system of the invention, in the message box, the transmitting processor and the receiving processor which is identical to the transmitting processor may correspond to an address in a matrix form. Therefore, a message can be more reliably transmitted and received to and from itself.

According to the multi-processor system, in the message box, the amount of storable messages may be determined according to the combination of the transmitting processor and the receiving processor. Therefore, a plurality of messages can be more reliably exchanged.

According to the multi-processor system, a busy flag, which is in an ON state when a message is stored at a receiving side address, may be stored in the message box, and the transmitting processor may write a message which is destined for the receiving processor at the corresponding address of the message box when the stored busy flag is in an OFF state. Therefore, it can be relatively easy to determine using a flag whether or not a message can be written.

According to the multi-processor system, the interrupt signal output unit may include a signal generating circuit which generates an interrupt signal which is destined for the receiving processor when a message is written for that address. Therefore, the interrupt signal can be output more rapidly compared to when the interrupt signal is output by software.

According to another aspect of the invention, there is provided a fluid ejecting apparatus, including: any one of the multi-processor systems described above; and a fluid ejecting mechanism which ejects fluid to form an image on a target, wherein the two or more processors are included which include at least one processor which generates image data formed by ejecting the fluid onto the target and one processor which drives and controls the fluid ejecting mechanism. Since the multi-processor system of the invention can more reliably exchange messages between processors, the fluid ejecting apparatus having the multi-processor system has the same effects.

### BRIEF DESCRIPTION OF THE DRAWINGS

The invention will be described with reference to the accompanying drawings, wherein like numbers reference like elements.

FIG. 1 is a configuration diagram of a configuration of a printer 20 according to an embodiment of the invention; and

FIG. 2 is a sequence diagram illustrating processing and communication aspects.

### DESCRIPTION OF EXEMPLARY EMBODIMENTS

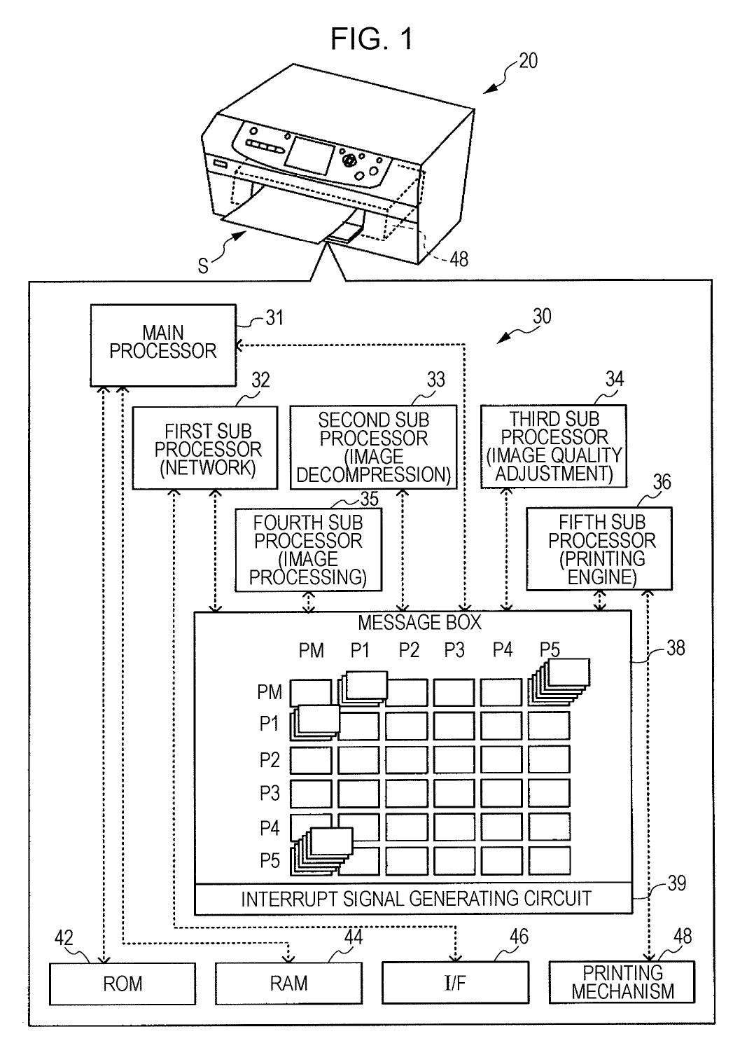

Hereinafter, embodiments of the invention will be described with reference to the attached drawings. FIG. 1 is a configuration diagram illustrating a configuration of a printer 20 used as a fluid ejecting apparatus according to a first embodiment of the invention. The printer 20 according to the first embodiment includes a multi-processor system 30 which controls the whole apparatus, an interface (I/F) 46 which supports the input and output of information to and from an external apparatus such as a personal computer, and a printing mechanism 48 which performs processing of printing an image on a recording paper S.

The multi-processor system 30 includes a main processor 31 which is in control of main control, first to fifth sub processors 32 to 36 which perform individual processing, a message box 38 which stores messages exchanged between processors, an interrupt signal generating circuit 39 which is a circuit for generating an interrupt signal, a read only memory (ROM) 42 which stores a variety of programs, and a random access memory (RAM) 44 which temporarily stores data. The main processor 31 and each sub processor are configured with a unit which includes peripheral circuits such as a central processing unit (CPU), a cache memory and a bus controller which are not illustrated in the drawing. The first sub processor 32 controls data related to a network, is electrically connected to the message box 38 and the I/F 46 and is able to access the message box 38 and the I/F 46. Further, the main processor 31 and each sub processor are individually electrically connected to the ROM 42 and the RAM 44. The second sub processor 33 decompresses compressed image files (for example, a JPEG file), is electrically connected to the message box 38 and is able to access the message box 38. The third sub processor 34 adjusts the image quality of decompressed image data, is electrically connected to the message box 38 and is able to access the message box 38. The fourth sub processor 35 performs imaging processing for rotating, shifting, enlarging, or scaling down image data, is electrically connected to the message box 38 and is able to access the message box 38. The fifth sub processor 36 drives and controls the printing mechanism 48 based on image data so as to perform printing processing, is electrically connected to the message box 38 and the printing mechanism 48 and is able to access the message box 38 and the printing mechanism 48.

The message box 38 includes a memory circuit in which messages are stored which have been sent from a transmitting processor to be destined for a receiving processor, which each correspond to one of the two or more processors mentioned above and which include the main processor 31, at an address in a matrix form which correspond to the transmitting processor and the receiving processor. In the message box 38, the transmitting processor and the receiving processor which is identical to the transmitting processor correspond to an address in a matrix form. That is, an address is conferred to a combination in which the transmitting processor and the receiving processor are the same processor as well as a combination in which the transmitting processor and the receiving processor are different processors. In the message box 38, the amount of storable messages is appropriately determined according to the combination of the transmitting processor and the receiving processor. For example, the message box 38 may be configured to be able to store three messages for the combination between the main processor 31 which requests a relatively large message amount and the first sub processor 32 used for the network, six messages for message exchange between the main processor 31 which performs a plurality of processing jobs and the fifth sub processor 36 used for the printing mechanism 48, and one message for each of the other processor combinations. Further, in the message box 38, a busy flag, which is in an ON state when a message is stored at a receiving side address, is stored corresponding to each receiving processor.

The interrupt signal generating circuit 39 is a circuit which generates an interrupt signal and output the interrupt signal to the receiving processor corresponding to the address at which the message is stored when the message is stored in the message box 38. The receiving processor is configured to receive the interrupt signal, read a register of the message box 38 and perceives which processor is the transmitting processor based on the address at which the message is stored.

The printing mechanism 48 is a mechanism of an ink jet type which applies pressure to each color of ink and ejects the pressurized ink onto the recording paper S so as to perform the printing processing, which is not illustrated in the drawing. Further, as a mechanism which applies pressure to ink, technique may be employed which uses deformation of a piezoelectric element or a technique which uses air bubbles generated by heat of a heater.

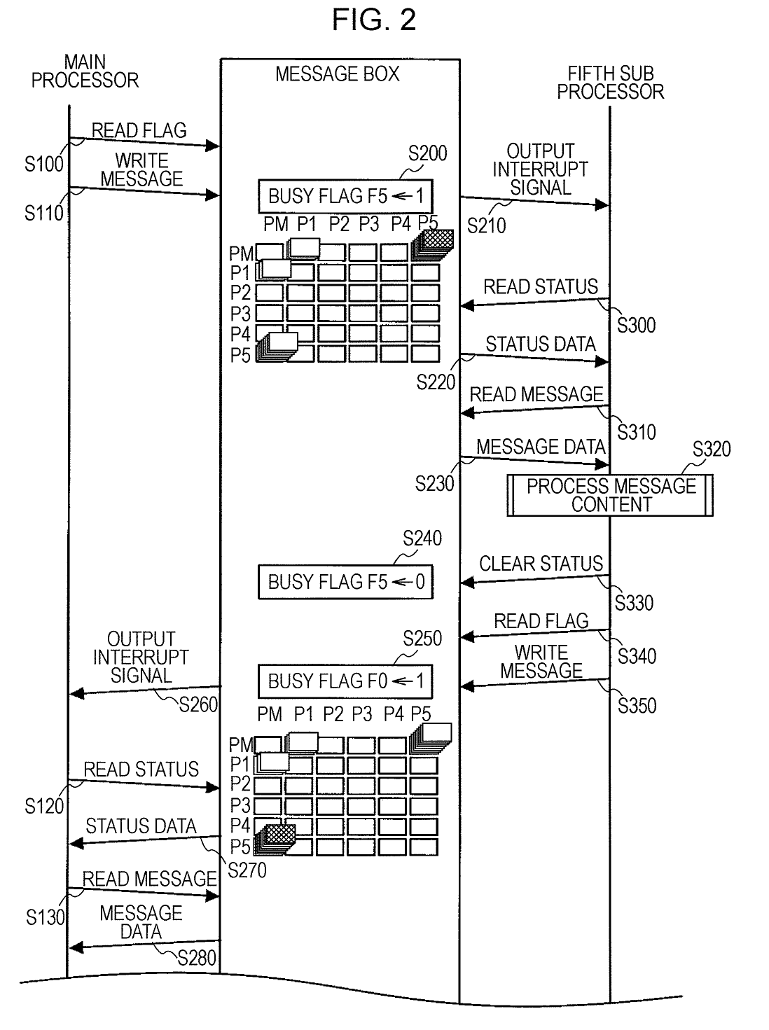

Next, operation of the printer 20 of the present embodiment configured as described above will be described. Here, operation of the printer 20 will be described focusing on processing in which a message is transmitted from the main processor 31 to the fifth sub processor 36 and then the fifth sub processor 36 responds to the main processor 31. FIG. 2 is a sequence diagram illustrating processing and communication aspects which are performed through the main processor 31, the fifth sub processor 36 and the message box 38. First, the main processor 31 reads a busy flag F5 of the fifth sub processor 36 which is the destination of the message stored in the message box 38 and checks whether or not a message which is destined for the fifth sub processor 36 is able to be stored in the message box 38 (step S100). Here, it is assumed that a busy flag F0 is used when the main processor 31 is the receiving side, and a busy flag F5 is used when the fifth sub processor 36 is the receiving side. When a busy flag has a value of “1”, it is determined that the receiving side is in a busy state. When the busy flag F5 has a value of “0”, the main processor 31 writes a message to the address in the message box 38 to which the main processor 31 as the transmitting side and the fifth sub processor 36 as the receiving side correspond (step S110). Here, FIG. 2 illustrates an image in which a message is written to an address in which the horizontal axis is PM (the main processor 31) and the vertical axis is P5 (the fifth sub processor 36) (see hatching).

The message box 38 in which the message is written assigns a value of “1” to the busy flag F5 (step S200). The interrupt signal generating circuit 39 outputs an interrupt signal to the fifth sub processor 36 corresponding to the address to which the message is written (step S210). The fifth sub processor 36 which has received the interrupt signal reads the status of the message box 38 which shows that a message is written in the message box 38 which is addressed to itself (step S300). The message box 38 outputs the status to the fifth sub processor 36 (step S220). The fifth sub processor 36 which has received the status perceives that a message has arrived from the main processor 31 and reads the stored message (step S310). Therefore, message data is output from the message box 38 (step S230). The fifth sub processor 36 which has received the message data performs the processing corresponding to the message content, for example, processing of the printing of image data (step S320).

Next, the fifth sub processor 36 clears the status of the message box 38 (step S330), and thus the message box 38 assigns a value of “0” to the busy flag F5 of the fifth sub processor 36 (step S240). Subsequently, the busy flag F0 of the main processor 31 is read (step S340). When a value of “0” is assigned to the busy flag F0, the fifth sub processor 36 performs the processing of writing a response message to an address of the message box 38 to which the fifth sub processor 36 corresponds to the transmitting side and the main processor 31 corresponds to the receiving side (step S350). Here, FIG. 2 illustrates an image in which a message is written to an address in which the horizontal axis is P5 and the vertical axis is PM (see hatching).

The message box 38 in which a message is written assigns a value of “1” to the busy flag F0 (step S250). The interrupt signal generating circuit 39 outputs an interrupt signal to the main processor 31 corresponding to the address at which a message is written (step S260). The main processor 31 which has received the interrupt signal reads the status of the message box 38 which represents that a message is written in the message box 38 which is addressed to itself (step S120). The message box 38 outputs the status to the main processor 31 (step S270). The main processor 31 which has received the status perceives that a message is arrived from the fifth sub processor 36 and reads the stored message (step S130). Therefore, message data is output from the message box 38 (step S280). The main processor 31 which has received the message data performs the processing corresponding to the message content. As described above, in the multi-processor system 30, each processing is transferred between processors through the message box 38 in which the transmitting side and the receiving side correspond in a matrix form.

The printer 20 of the present embodiment described above in detail includes the message box 38 in which messages are stored which have been sent from a transmitting processor to be destined for a receiving processor, which each correspond to one of the two or more processors mentioned above and which include the main processor 31, at an address in a matrix form which correspond to the transmitting processor and the receiving processor. When a message is written in the message box 38, the interrupt signal generating circuit 39 outputs an interrupt signal to the receiving processor. Since the receiving side and the transmitting side correspond to an address in a matrix form as described above, it is easy to perceive the relationship between the transmitter and the receiver. Further, when a message is written, this is informed to the receiving side, and thus it is easy for the receiving side to perceive whether or not a message is present. Therefore, a message can be reliably exchanged between processors. Further, since the transmitting side and the receiving side which is identical to the transmitting side correspond to an address in a matrix form in the message box 38, for example, since a message may be transmitted to itself if tasks are different, a message can be more reliably transmitted and received to and from itself. Further, since the amount of messages which can be stored in the message box 38 is determined according to the combination of the transmitting side and the receiving side, a plurality of messages can be more reliably exchanged. Furthermore, a transmitting processor writes a message which is destined for a receiving side to a corresponding address of the message box 38 when a busy flag is in an OFF state. Therefore, it can be relatively easy to determined using a flag whether or not the message can be written. In addition, when a message is written to an address of the message box 38, an interrupt signal which is destined for the receiving processor is generated through the interrupt signal generating circuit 39. Therefore, the interrupt signal can be output more rapidly compared to when the interrupt signal is generated by software. Furthermore, the printer 20 frequently performs processing such as image decompression, image adjustment or image printing by a plurality of processors and thus there would be a great significance in mounting the multi-processor system 30.

The invention is not limited to the above-described embodiment, and it would be understood that various embodiments and modifications can be made within the technical scope of the invention.

For example, in the embodiment described above, in the message box 38, a transmitting processor and a receiving processor which is identical to the transmitting processor correspond to an address in a matrix form. However, in the message box 38, a transmitting processor and a receiving processor which is different from the transmitting processor may correspond to an address in a matrix form.

In the embodiment described above, a busy flag is used, but the busy flag may not be used.

In the embodiment described above, the storable message amount is determined according to the combination between a transmitting side and a receiving side. However, the invention is not limited to it, and, for example, the storable message amount may be fixed. However, the former method is preferable from the point of view of effective utilization of memory capacity.

In the embodiment described above, an interrupt signal is output through the interrupt signal generating circuit 39. However, the interrupt signal may be output through a method using software.

In the embodiment described above, the printer 20 includes the multi-processor system 30. However, a device which performs the processing through a plurality of processors may include the multi-processor system 30, and the invention is not limited to the printer 20. For example, the multi-processor system 30 may be mounted in devices such as a personal computer, a television, a video device, a game machine, or the like.

In the embodiment described above, the printer 20 is described as an example of a fluid ejecting apparatus. A printing apparatus may be used which ejects liquid other than an ink, a liquid-like substance (a dispersion liquid) in which particles of a function material are dispersed, or a fluid-like substance such as gel. A printing apparatus may be used which ejects a solid substance which can be ejected as a liquid. Examples of the fluid ejecting apparatus include a liquid ejecting apparatus which ejects a liquid in which a material is dispersed such as an electrode material or a coloring material, which is used to manufacture a liquid display device (LCD), an electroluminescence (EL) display device, a plane emission display, and a color filter, a liquid-formed substance ejecting apparatus which ejects a liquid-like substance in which the same material as described above is dispersed, and a liquid ejecting apparatus which ejects a liquid which is a sample used as a precise pipette. Further, a liquid ejecting apparatus may be used which ejects a transparent resin liquid such as ultraviolet cured resin on a substrate to form a minute hemispheric lens (optical lens) used in an optical communication element or the like, a liquid-formed substance ejecting apparatus may be used which ejects gel, and a fine particle ejection type recording apparatus may be used which ejects a fine particle such as toner.

What is claimed is:

1. A multi-processor system, comprising:
two or more processors;
a message box in which messages are stored which have been sent from a transmitting processor to be destined for a receiving processor, which each correspond to one of the two or more processors, at an address in a matrix form which correspond to the transmitting processor and the receiving processor; and
an interrupt signal output unit which outputs an interrupt signal to the receiving processor when a message is written in the message box.

2. The multi-processor system of claim 1, wherein in the message box, the transmitting processor and the receiving processor which is identical to the transmitting processor correspond to an address in a matrix form.

3. The multi-processor system of claim 1, wherein in the message box, the amount of storable messages is determined according to the combination of the transmitting processor and the receiving processor.

4. The multi-processor system of claim 1, wherein a busy flag, which is in an ON state when a message is stored at a receiving side address, is stored in the message box, and the transmitting processor writes a message which is destined for the receiving processor at the corresponding address of the message box when the stored busy flag is in an OFF state.

5. The multi-processor system of claim 1, wherein the interrupt signal output unit includes a signal generating circuit which generates an interrupt signal which is destined for the receiving processor when a message is written to that address.

6. A fluid ejecting apparatus, comprising:
a multi-processor system according to claim 1; and
a fluid ejecting mechanism which ejects a fluid to form an image on a target,
wherein the two or more processors are included which include at least one processor which generates image data formed by ejecting the fluid onto the target and one processor which drives and controls the fluid ejecting mechanism.
